(19) United States
(12) Patent Application Publication
(10) Pub. No.: US 2024/0084537 A1
(43) Pub. Date: Mar. 14, 2024

(54) PORTAL FRAME PLATFORM AND CONSTRUCTION METHOD FOR LARGE OFFSHORE WIND TURBINES

(71) Applicant: Jin Wang, Houston, TX (US)

(72) Inventor: Jin Wang, Houston, TX (US)

(73) Assignee: JIN WANG, Houston, TX (US)

(21) Appl. No.: 17/941,775

(22) Filed: Sep. 9, 2022

(51) Int. Cl. E02B 17/02; E02D 27/42; E02D 27/52; F03D 13/25

(52) U.S. Cl. CPC E02B 17/027; E02D 27/425; E02D 27/525; F03D 13/25; E02B 2017/0047; F05B 2240/95

(57) ABSTRACT

A portal frame platform comprises at least three elongate tubular legs extending vertically downward from a top above the waterline to the seabed without horizontal or diagonal bracing members in-between, and a horizontal deck with at least three circular sleeves concentrically coupled to the top of the legs supporting a wind turbine in an in-service configuration. The portal frame platform supporting the wind turbine has an installation configuration with two barges connected to opposite sides of the deck, and the legs extending vertically upward from a bottom above the waterline through the circular sleeves. A construction method includes twelve-steps for quayside assembling, sea-towing and self-installing the portal frame platform with the wind turbine and foundation piles wherein the portable frame platform is converted from the installation configuration to the in-service configuration by lowering the legs through the circular sleeves using wire and winch systems on the two barges.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCES

### U.S. Patent Documents

U.S. Pat. No. 7,819,073 B2, Sveen et al., October 2010
U.S. Pat. No. 8,689,721 B2, Wang, April 2014
U.S. Pat. No. 9,139,266 B2, Roddier et al., September 2015
U.S. Pat. No. 9,394,035 B2, Dagher et al., July 2016

### OTHER PUBLICATIONS

International Renewable Energy Agency (IRENA), “Floating Foundations: a Game Changer for Offshore Wind Power”, 2016.
Evan Gaertner, et al, “Definition of the IEA Wind 15-Megawatt Offshore Reference Wind Turbine”, NREL/TP-5000-75698, National Renewable Energy Laboratory, March 2020. Office of Energy Efficiency and Renewable Energy, U.S. Department of Energy (DOE), “Offshore Wind Market Report—2021 Edition”, August 2021.
Lisa Friedman, “Sale of Leases for Wind Farms Off New York Raises More Than $4 Billion”, The New York Times, Feb. 25, 2022.

### FIELD OF INVENTION

Embodiments of present disclosure relate generally to the field of offshore structures. More specifically, embodiments of present disclosure relate to a bottom-founded portal frame platform supporting a large offshore wind turbine and construction method without using heavy lift vessels.

### BACKGROUND OF THE INVENTION

Presently, most of the offshore wind turbines installed are supported by bottom-founded substructures in less than 30 meters of water depth with power generation capacity less than 10 MW. As demand for offshore wind power increases, there is a growing trend to deploy large wind turbines with power generation capacity greater than 10 MW in water depth of over 30 meters.

For large offshore wind turbines, it is generally considered that bottom-founded substructures are mostly suitable for water depth less than 60 meters beyond which floating platforms become more attractive economically. Floating wind platform technologies have progressed markedly in recent years with various novel floating platform concepts invented. Examples of such inventions are U.S. Pat. No. 7,819,073B2 (2010), U.S. Pat. No. 8,689,721B2 (2014), U.S. Pat. No. 9,139,266B2 (2015), and U.S. Pat. No. 9,394,035B2 (2016). Some of these novel concepts have been or planned to be deployed to offshore wind farms for commercial power generation in water depth ranging from 50 meters to over 500 meters according to industry and government publications. In contrast to recent advancement in floating wind platform technologies, bottom-founded substructures for offshore wind turbines have not advanced significantly. Specifically, monopiles and jackets invented decades ago for offshore oil and gas development are widely used as substructures for offshore wind turbines in nearly all existing commercial offshore wind energy developments.

FIG. 1A illustrates a side view of an exemplary bottom-founded offshore wind turbine supported by a monopile type substructure according to the prior art. FIG. 1B illustrates a side view of an exemplary bottom-founded offshore wind turbine supported by a jacket type substructure according to the prior art. The monopile is typically a single cylindrical pipe with one end embedded in the soil extending from the seabed through a cylindrical transition pipe in mid-water to above the waterline connecting to the bottom of the wind tower. The main advantage of the monopile is that it has a simple circular structural form and can be fabricated at low cost utilizing automated welding. On the other hand, the monopile is not efficient in resisting bending moment from wind and wave loads compared with the jacket type substructure.

The jacket is typically a steel tubular space frame structure consisting of at least three vertical or battered legs extending from the seabed to above the sea surface connecting to a horizontal deck supporting the wind tower, and diagonal and horizontal bracing members connecting the elongate tubular legs at various elevations. The jacket is typically fixed to the seabed by driven skirt piles. For offshore wind turbines, the diameter of the jacket leg is typically less than 2 meters. The main advantage of the jacket is that it has a light-weight lattice structural design and is highly efficient in resisting bending moment. On the other hand, the jacket typically has a much higher fabrication cost than the monopile due to structural complexity.

The monopile is presently by far the most widely deployed bottom-founded substructure type due to its simple circular design, efficient fabrication, quick installation, and easy adaptability with various sizes (diameter and length) for different water depth and seabed soil conditions. For most existing offshore wind turbines smaller than 10 MW in water depth less than 30 meters, the diameter of the monopile is typically between 6 to 8 meters. As the size of the wind turbine grows bigger and water depth increases, the bending moment at the bottom of the monopile increases significantly due to increased wind tower height and greater wind and wave loads, particularly for water depth more than 30 meters. This in turn causes the monopile diameter and wall thickness to increase significantly resulting in increased steel weight. For example, a 15 MW wind turbine typically has a rotor diameter of approximately 240 meters and a wind tower height of approximately 150 meters from the sea level. For a water depth of 40 meters, a monopile may have a diameter of 10 meters or more, 75 mm or more in wall thickness, 100 meters or more in length, and total steel weight exceeding 2000 metric tons.

For water depth of greater than 40 meters, the jacket type substructure may become the better option according to the prior art for large offshore wind turbines because the conventional monopile may not be feasible due to increased bending moment at the bottom, structural dynamic response and fatigue caused by the dynamic aspects of the wind and wave loading, as well as pile driving limitations. The weight of the monopile would be more than the weight of the jacket if the size of the monopile is increased to meet the increased design requirements. Although the weight of the jacket is less sensitive to water depth increase than the monopile, it still increases with the water depth, and could exceed 3000 metric tons for a water depth of 60 meters with increased overall length and width, as well as structural member sizes.

The conventional way for deploying a bottom-founded offshore wind turbine generally need at least two offshore installation campaigns involving large installation vessels. The first is to install the substructure (monopile or jacket). The substructure is assembled on-shore, then load-out onto a large transportation vessel and towed to the offshore wind farm site, then a large heavy lift vessel is used to lift the substructure upright and lower it to the seabed. For the monopile, the bottom will be driven into the soil by a large hammer and the top will be connected to a transition pipe extending above the water surface. For the jacket, the bottom of the elongate tubular legs will be grouted to pre-installed skirt piles at the seabed. The second campaign is to install the wind turbine generator components, i.e., wind turbine tower, nacelle, and rotor blades in sequence, onto the substructure using a heavy lift vessel.

Unlike offshore oil and gas development which typically require one or two platforms for one field, the number of wind turbines and substructures required for offshore wind energy development usually exceeds 50 for one wind farm. This causes several scaling-up challenges for the conventional jacket type substructures in terms of fabrication, transportation, and offshore installation. First, it is very difficult to produce a large quantity (e.g., 50 or more) of jacket substructures in a timely and cost-effective manner with the conventional fabrication method based on customized fabrication sequence requiring specialized heavy equipment, large yard space and significant amount of manual welding. Second, it requires large transportation vessels to transport the jackets and wind turbines from the fabrication yard to the offshore wind farm site, and the number of such transportation vessel is limited. Third, it requires large specialized heavy lift vessels with crane lift capacity of 2500 metric tons or more to install the jackets and wind turbines, and such heavy lift vessels are extremely scarce in supply and very costly (typically more than $500 million per unit) to build. Furthermore, there are currently acute shortage of suitable fabrication yards and Jones Act (a law requiring that all goods transported by water between U.S. ports be carried on ships that have been constructed in the United States and that fly the U.S. flag, are owned by U.S. citizens, and are crewed by U.S. citizens and U.S. permanent residents) compliant heavy lift vessels in the US for installing the large jacket substructures and wind turbines.

For the monopile substructure, the above scaling-up problems remain for transportation and offshore installation using heavy lift vessels, particularly for large offshore wind turbines in water depth greater than 30 meters. In addition, the driving of a large diameter monopile into the seabed needs a large hammer with increased energy consumption which may exceed the existing hammer equipment capacity and makes huge noise which could cause serious harm to marine lives. The fabrication problem for the monopile may be less than the jacket. However, as the diameter of the monopile grows bigger, large manufacturing equipment and crane lift capacity will be needed.

The above shortcomings in conventional monopile and jacket type substructures are the root causes for the current high cost and severe project schedule bottle-neck issues facing the offshore wind industry. There is a strong need for a new type of substructure and installation method without using heavy lift vessels in order to reduce cost and improve project schedule.

### SUMMARY OF THE INVENTION

The present disclosure overcomes the above problems for the monopile and jacket type substructures by providing a portal frame platform supporting a large wind turbine system and construction method for quayside assembly, sea-towing, and offshore self-installation without using heavy lift vessels. The portal frame platform includes at least three elongate tubular legs extending vertically downward from a top above the waterline to the seabed without horizontal or diagonal bracing members in-between, and a horizontal deck with at least three circular sleeves concentrically coupled to the top of the legs supporting a wind turbine system in an in-service configuration. The wind turbine system has a wind tower with a bottom vertically coupled to the horizontal deck at a center above the waterline and a top coupled to a nacelle and plurality of rotor blades. The bottom of each of the elongate tubular legs is coupled to a foundation pile embedded into the seabed.

In some embodiments as shown in FIG. 3A, the portal frame platform comprises four vertical elongate tubular legs each located at a corner of a square pattern, four foundation piles each having an upper end coupled to a bottom of each of the elongate tubular legs. The horizontal deck consists essentially of four circular sleeves equally spaced from the center each concentrically coupled to an upper section of each of the elongate tubular legs, a base section at the center vertically coupled to the bottom of the wind turbine tower, and four horizontal girders connecting radially the base section to the circular sleeves.

In some embodiments, the circular sleeve comprises a circular outer shell having a height approximately equal to the height of the horizontal girder, a plurality of inner guiding elements vertically coupled to the inside of the circular outer shell, and an inner annulus plate horizontally coupled to the lower end of the circular outer shell, wherein an inner diameter of the inner annulus plate approximately equals to a diameter of a circle formed by the inner guiding elements.

In some embodiments, the elongate tubular leg comprises an upper section, a lower section, and a mid-section, wherein the upper section having a watertight cover plate, a circular shell, a plurality of outer guiding bars vertically coupled to the outside of the circular shell, and an outer annulus plate horizontally coupled to the circular shell at a vertical distance below the watertight cover plate approximately equal to the height of the circular sleeve of the horizontal deck. The dimensions of the outer annulus plate of the upper section of each of the elongate tubular legs are approximately the same as that of the inner annulus plate of each of the circular sleeves of the horizontal deck.

In some embodiments, an inner diameter of the inner annulus plate of the circular sleeve of the horizontal deck is at least 1 inch greater than an outer diameter of the elongate tubular leg with the outer guiding bars, wherein the elongate tubular leg can move from the lower section to the upper section vertically through an open circle of the inner annulus plate of the circular sleeve until stopped at the outer annulus plate of the upper section.

In some embodiments as shown in FIG. 4A, the portal frame platform is in an in-service configuration at an offshore site in approximately 60 meters water depth, wherein the upper section of each of the elongate tubular legs is coupled rigidly to each of the circular sleeves of the horizontal deck above the waterline, and the foundation piles are embedded into the seabed each having a top coupled to a bottom of each of the elongate tubular legs.

In some embodiments as shown in FIG. 4B, the portal frame platform is in a quayside assembly configuration at an assembly yard in a relative shallow water, wherein the lower section of each of the elongate tubular legs is concentrically located inside of each of the circular sleeves of the horizontal deck above the water line and the foundation piles vertically stand on the seabed.

In some embodiments as shown in FIG. 5 to FIG. 7, the circular sleeve of the horizontal deck is concentrically coupled to the upper section of the elongate tubular leg, wherein the space in the annulus gap between the outer shell of the circular sleeve and the outer shell of the upper section of the elongate tubular leg is filled with grout forming a rigid connection.

In some embodiments as shown in FIG. 8 to FIG. 10B, an upper section of the elongate tubular leg comprises a vertical web plate connecting to a top horizontal extending plate at an upper end and a horizontal watertight cover plate of the elongate tubular leg coupled to an outer annulus plate at a lower end of the vertical web plate. The dimensions of the outer annulus plate of the upper section of the elongate tubular leg are approximately the same as that of an inner annulus plate coupled to the lower end of the circular sleeve of the horizontal deck. The elongate tubular leg is rigidly coupled to various parts of the horizontal deck with bolted connections through the top horizontal extending plate, vertical web plate, and the outer annulus plate.

In some embodiments as shown in FIG. 11A, the portal frame platform is in an offshore installation configuration with two barges connected to opposite sides of the horizontal deck supporting the wind turbine system and the elongate tubular legs extending vertically upward from the bottom through the circular sleeves of the horizontal deck above the waterline. The two barges are equipped with deck support structures and wire and winch systems forming a catamaran providing buoyancy and stability for the entire assembly of the portable frame platform with the wind turbine system and pile foundations during sea-towing and offshore installation, wherein lateral guides are installed to the top of the elongate tubular legs with a spring device compressed to the wind tower.

In some embodiments as shown in FIG. 14 to FIG. 25, a construction method for quayside assembling, sea-towing and offshore self-installing a portal frame platform comprises twelve steps, wherein the portable frame platform first has a quayside assembly configuration with the elongate tubular legs extending vertically upward from the bottom through the circular sleeves of the horizontal deck for vertical integration with the wind turbine system at a quayside, second has an offshore installation configuration for sea-towing and self-installation by connecting two barges to opposite sides of the horizontal deck forming a catamaran floating system providing buoyancy and stability, and third the portal frame platform is converted from the offshore installation configuration into the in-service configuration by lowering the elongate tubular legs with the foundation piles to the seabed utilizing the wire and winch systems, embedding the foundation piles into the seabed, and disconnecting and pulling away the two barges.

The foundation piles are preferred to be of a suction caisson type as they can be installed together with the portable frame platform during one offshore installation process as described above.

In some embodiments as shown in FIG. 26 to FIG. 29, the foundation piles of the portable frame platform are of a driven pile type for soil condition not favorable to the suction caisson type. The driven piles are installed in advance by impact hammer forces. The portable frame platform is assembled at a quayside and installed offshore with a self-installing process similar to the construction method described above, wherein each of the driven piles has an upper section above the seabed coupled a pile adaption section attached to each of the lower section of the elongate tubular legs by grout.

In summary, the portal frame platform in accordance with the present disclosure has distinct features providing a feasible and low-cost solution for the problems of the prior art monopile and jacket type substructures, particularly for large wind turbines in water depth more than 30 meters.

First, the portal frame platform can resist a much greater bending moment than a monopile with similar steel weight, particularly for water depth more than 30 meters. Second, the components of the portable frame platform can be fabricated more efficiently at lower cost than a large diameter monopile or a space frame jacket structure with similar steel weight because of its simple design with just three or four small diameter tubular legs without horizontal or diagonal bracing members. Third, the portal frame platform can be assembled and integrated with the wind turbine system and foundation piles at a quayside while the monopile and the jacket cannot. Forth, no large transportation vessel is needed to transport the portal frame platform from the fabrication yard to the offshore wind farm site while large transportation vessels are needed for the monopile and the jacket. Fifth, the portal frame platform can be installed with the foundation piles and the wind turbine system together with just one offshore installation campaign utilizing regular deck barges while the monopile and the jacket need large specialized heavy lift vessels with multiple offshore installation campaigns. Thus, the portal frame platform can significantly reduce the high cost and long schedule due to the shortage of heavy lift vessels. It is estimated that the cost of the portable frame platform can be 30% to 50% lower than the monopile and the jacket, particularly for large wind turbines in water depth greater than 30 meters.

In addition to the above advantages, it is highly feasible to economically fabricate, assemble, transport, and install the portable frame platform utilizing local resources and existing port facilities without import from overseas, thus creating new jobs and other benefits for the local community.

### BRIEF DESCRIPTION OF DRAWINGS

FIG. 1A is a schematic side view of an exemplary monopile type substructure supporting a large wind turbine according to the prior art.

FIG. 1B is a schematic side view of an exemplary jacket type substructure supporting a large wind turbine according to the prior art.

FIG. 2 is a schematic side view of an exemplary embodiment of a portal frame platform supporting a large wind turbine in accordance with the present invention.

FIG. 3A is a schematic perspective view of an exemplary embodiment of the portal frame platform having four elongate tubular legs.

FIG. 3B is a schematic perspective view of an exemplary embodiment of the portal frame platform having three elongate tubular legs.

FIG. 4A is a schematic detailed side view of an exemplary embodiment of the portal frame platform having an in-service configuration.

FIG. 4B is a schematic detailed side view of an exemplary embodiment of the portal frame platform having a quayside assembly configuration.

FIG. 5 is a schematic detailed perspective view of an exemplary embodiment of a circular sleeve of the horizontal deck of the portal frame platform.

FIG. 6 is a schematic detailed perspective view of an exemplary embodiment of an upper section of the elongate tubular leg of the portal frame platform.

FIG. 7 is a schematic detailed perspective view of an exemplary embodiment of the circular sleeve coupled to the upper section of the elongate tubular leg with grout connection.

FIG. 8 is a schematic detailed perspective view of an exemplary embodiment of a circular sleeve coupled to a horizontal girder of the horizontal deck of the portal frame platform.

FIG. 9 is a schematic detailed perspective view of an exemplary embodiment of an upper section of the elongate tubular leg having a vertical web plate and a top horizontal extending plate.

FIG. 10A is a schematic detailed perspective view of an exemplary embodiment of the circular sleeve coupled to the upper section of the elongate tubular leg with bolted connection.

FIG. 10B is a schematic detailed plan view of an exemplary embodiment of the circular sleeve coupled to the upper section of the elongate tubular leg with bolted connection.

FIG. 11A is a schematic perspective view of an exemplary embodiment of the portal frame platform having four legs in an offshore installation configuration with two barges.

FIG. 11B is a schematic perspective view of an exemplary embodiment of the portal frame platform having three legs in an offshore installation configuration with two barges.

FIG. 12 is a schematic detailed perspective view of an exemplary embodiment of lateral guides on the top of the legs each having a spring device compressed to the wind tower.

FIG. 13 is a schematic detailed perspective view of an exemplary embodiment of two barges equipped with deck support structures and wire and winch systems connected to opposite sides of the horizontal deck of the portable frame platform in the offshore installation configuration.

FIG. 14 is a schematic view of an exemplary embodiment of a sub-assembly of the foundation piles during a 1st step of a construction method for assembling a portable frame platform supporting a large wind turbine in accordance with the present disclosure.

FIG. 15 is a schematic view of an exemplary embodiment of a horizontal deck with circular sleeves coupled to the sub-assembly of the foundation piles during a 2nd step of the construction method following the 1st step.

FIG. 16 is a schematic view of an exemplary embodiment of two legs on a distal side from a quay coupled to the foundation piles through the circular sleeves of the horizontal deck during a 3rd step of the construction method following the 2nd step.

FIG. 17 is a schematic view of an exemplary embodiment of a wind tower vertically coupled to a base section of the horizontal deck during a 4th step of the method following the 3rd step.

FIG. 18 is a schematic view of an exemplary embodiment of two legs on the proximal side from the quay coupled to the foundation piles through the circular sleeves of the horizontal deck during a 5th step of the method following the 4th step.

FIG. 19 is a schematic view of an exemplary embodiment of a wind turbine nacelle with rotor blades coupled to a top of the wind tower forming a quayside assembly configuration of the portable frame platform during a 6th step of the method following the 5th step.

FIG. 20 is a schematic view of an exemplary embodiment of two barges coupled to opposite sides of the horizontal deck forming an offshore installation configuration of the portable frame platform during a 7th step of the method following the 6th step.

FIG. 21 is a schematic view of an exemplary embodiment of a tugboat towing the portable frame platform connected to the two barges with the wind turbine system and the foundation piles in the offshore installation configuration during an 8th step of the method following the 7th step.

FIG. 22 is a schematic view of an exemplary embodiment of the portable frame platform being converted from the offshore installation configuration to an in-service configuration by lowing the legs utilizing wire and winch systems during a 9th step of the method following the 8th step.

FIG. 23 is a schematic view of an exemplary embodiment of the portable frame platform with the foundation piles landing on the seabed controlled by the wire and winch systems during a 10th step of the method following the 9th step.

FIG. 24 is a schematic view of an exemplary embodiment of the portable frame platform with the foundation piles embedded into the seabed while still connected to the two barges during a 11th step of the method following the 10th step.

FIG. 25 is a schematic view of an exemplary embodiment of the portable frame platform converted into the in-service configuration with the two barges disconnected and pulled away during a 12th step of the method following the 11th step.

FIG. 26 is a schematic front view of an exemplary embodiment of a portal frame platform with elongate tubular legs each with a pile adaption section concentrically coupled to a driven pile in an in-service configuration supporting a large wind turbine in accordance with the present invention.

FIG. 27 is a schematic detailed front view of an exemplary embodiment of the portal frame platform with a horizontal deck supporting a large wind turbine in a quayside assembly configuration without the driven piles.

FIG. 28 is a schematic front view of an exemplary embodiment of the portal frame platform supporting a large wind turbine in an offshore installation configuration with two barges connected to opposite sides of the horizontal deck forming a catamaran without the driven piles.

FIG. 29 is a schematic front view of an exemplary embodiment of the portal frame platform supporting a large wind turbine being converted from the offshore installation configuration into the in-service configuration, wherein the elongate tubular legs with the pile adaption section are lowered to the pre-installed driven piles during a self-installing process.

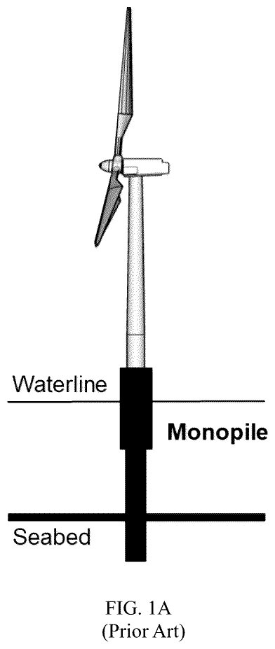

### DETAILED DESCRIPTION OF THE INVENTION

The present invention relates to a bottom-founded portal frame platform supporting a large offshore wind turbine and construction method without using heavy lift vessels. Before explaining the invention in detail, it is to be understood that the present invention is not limited to the embodiments as disclosed and that it can be practiced or carried out in various ways. It is understood that although the disclosed portable frame platform and construction method are generally intended for supporting large offshore wind turbines in water depth from 30 to 100 meters, it can be used in any body of water not limited by water depth, and with any type of topsides not limited to offshore wind turbines. In the text, if not specified, the use of relational terms, such as, but not limited to, “top,” “bottom,” “left,” “right,” “upper,” “lower,” “deeper,” “shallower,” “up,” “down,” “side,” and the like is for clarity in specific reference to the figures and is not intended to limit the scope of the invention or the claims.

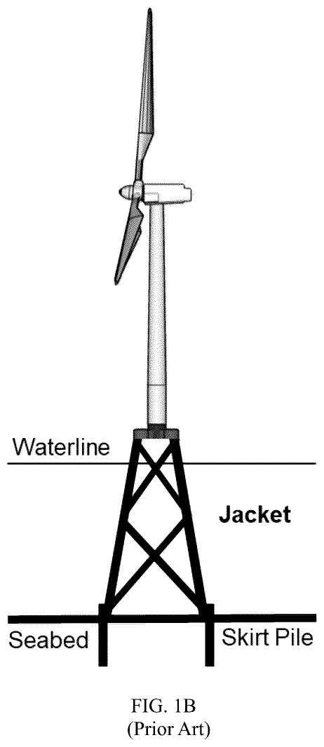

Preferred embodiments of the present invention are shown in FIGS. 2 through 29. Detailed descriptions are as follows.

With reference to FIG. 2, a portal frame platform 2 supporting a wind turbine system consisting essentially of a wind tower 4, a nacelle 6 and rotor blades 8 comprises a plurality of elongate tubular legs 12 extending vertically downward from above a waterline 101 to a seabed 201 without horizontal or diagonal bracing members between the elongate tubular legs 12, a horizontal deck 14 above the waterline 101, a plurality of foundation piles 16 embedded into the seabed 201, wherein each of the elongate tubular legs 12 is coupled to the horizontal deck 14 at a top and to each of the foundation piles 16 at a bottom, and a center of the horizontal deck 14 is coupled to a bottom of the wind tower 4. The portal frame platform 2 has a preferred service water depth range from 30 meters to 100 meters. The wind turbine system 4, 6, 8 has a preferred power generation capacity range from 10 MW to 20 MW. The elongate tubular legs 12 are preferred to be of steel construction with internal ring stiffeners having a preferred diameter range from 3 meters to 7 meters.

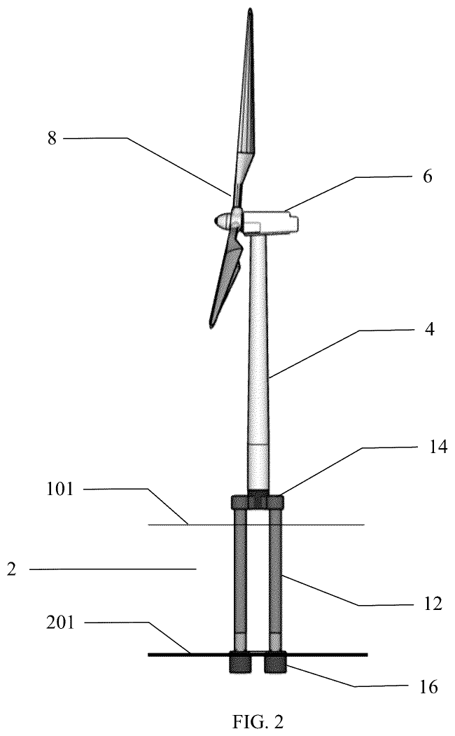

With reference to FIG. 3A, the portal frame platform 2 supporting the wind turbine system with a wind tower 4, a nacelle 6 and rotor blades 8 comprises four elongate tubular legs 12 each vertically located at a corner of a square pattern without horizontal or diagonal bracing members between the elongate tubular legs 12, a horizontal deck 14, and four foundation piles 16 each having a top coupled to a bottom of each of the elongate tubular legs 12. The horizontal deck 14 has four circular sleeves 14A with a diameter greater than a diameter of the elongate tubular legs 12 equally spaced radially from the center each concentrically coupled to an upper section 12A of each of the elongate tubular legs 12 forming a rigid connection, a base section 14B at the center vertically coupled to a bottom of the wind turbine tower 4, and four horizontal girders 14C each radially connecting the base section 14B to each of the circular sleeves 14A.

With reference to FIG. 3B, the portal frame platform 2 supporting a wind turbine system with a wind tower 4, a nacelle 6 and rotor blades 8 comprises three elongate tubular legs 12 each vertically located at a corner of an equilateral triangle pattern without horizontal or diagonal bracing members between the elongate tubular legs 12, a horizontal deck 14 with three circular sleeves 14A, a base section 14B at the center supporting the wind turbine system 4, 6, 8 and three horizontal girders 14C. Each of the elongate tubular legs 12 has an upper section 12A concentrically coupled to each of the circular sleeves 14A and a bottom coupled to a top of a foundation pile 16.

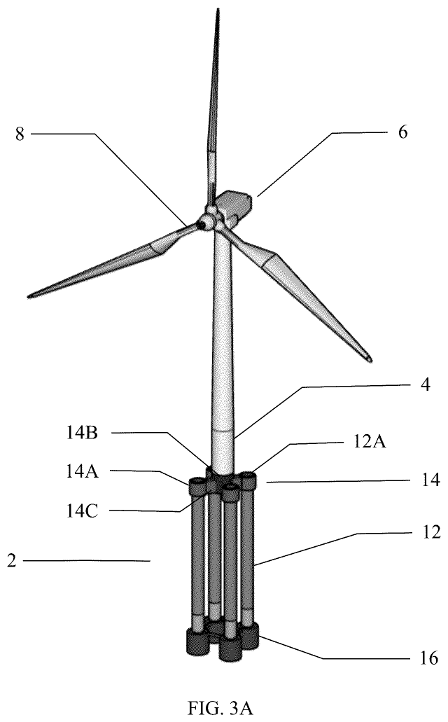

With reference to FIG. 4A, the portal frame platform 2 has an in-service configuration, as shown in approximately 60 meters water depth, comprising a plurality of elongate tubular legs 12 with a length at least 60 meters extending vertically downward from above a waterline 101A to a seabed 201A, a horizontal deck 14 having a plurality of circular sleeves 14A with a diameter greater than a diameter of the elongate tubular legs 12, and plurality of foundation piles 16 embedded below the seabed 201A, wherein each of the elongate tubular legs 12 having an upper section 12A coupled concentrically to the circular sleeve 14A of the horizontal deck 14 forming a rigid connection, and a lower section 12B with a bottom vertically coupled to a top of each of the foundation piles 16, wherein the horizontal deck 14 having a base section 14B at a center vertically coupled to a bottom of a wind turbine tower 4, and a plurality of horizontal girders 14C each connecting from a side of the base section 14B to a side of each of the circular sleeves 14A, wherein the foundation piles 16 are connected together horizontally by link beams 18 at a top just above the seabed 201A. The foundation piles 16 shown are of a suction caisson type with a relative short length and a large diameter substantially greater than the diameter of the elongate tubular legs 12 and embedded into the seabed 201A by suction forces.

With reference to FIG. 4B, the portal frame platform 2 has a quayside assembly configuration, as shown in approximately 8 meters water depth at a quayside, comprising the elongate tubular legs 12 extending vertically upward with the upper section 12A way above a waterline 101B, the horizontal deck 14 with each of the circular sleeves 14A and the lower section 12B of the elongate tubular legs 12 concentrically located at a similar elevation above the waterline 101B, and the foundation piles 16 standing on a seabed 201B of the quayside each having the top coupled to the bottom of each of the lower section 12B of the elongate tubular legs 12, wherein the base section 14B of the horizontal deck 14 is vertically coupled to the bottom of the wind tower 4, and the horizontal girders 14C each connecting from the side of the base section 14B to the side of each of the circular sleeves 14A, wherein the foundation piles 16 are connected together horizontally by the link beams 18 at the top just above the waterline 101B.

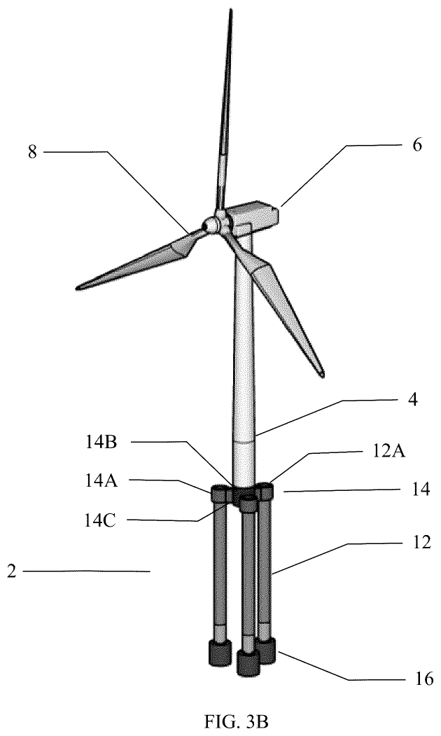

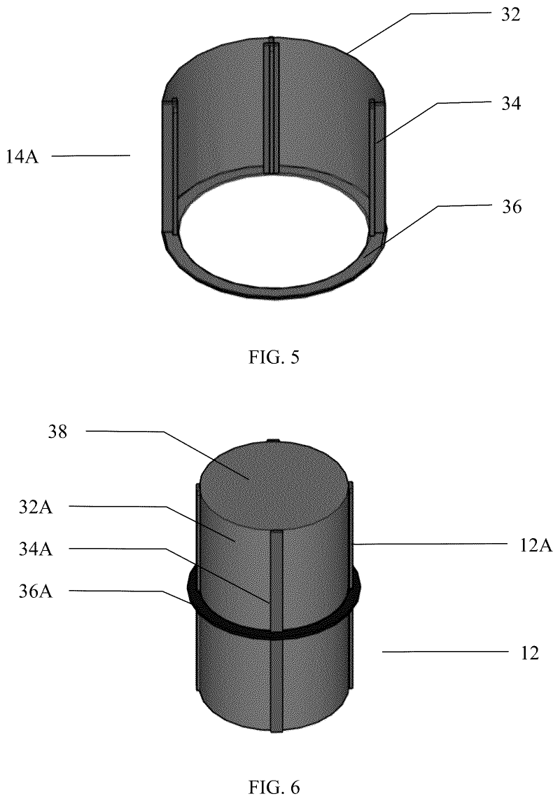

Further detailed descriptions are given below for the rigid connection between the upper section 12A of the elongate tubular leg 12 and the circular sleeve 14A of the horizontal deck 14 of the portal frame platform 2. The rigid connection can be of a grouted type or a bolted type. The grouted connection is described in FIG. 5 to FIG. 7. The bolted connection is described in FIG. 8 to FIG. 10B.

With reference to FIG. 5, in some embodiments, the circular sleeve 14A comprises a circular outer shell 32 having a diameter and a height, a plurality of inner guiding elements 34 vertically coupled to the inside of the circular outer shell 32, and an inner annulus plate 36 horizontally coupled to a lower end of the circular outer shell 32, wherein the inner annulus plate 36 has an inner diameter approximately equals to a diameter of a circle formed by the inner guiding elements 34.

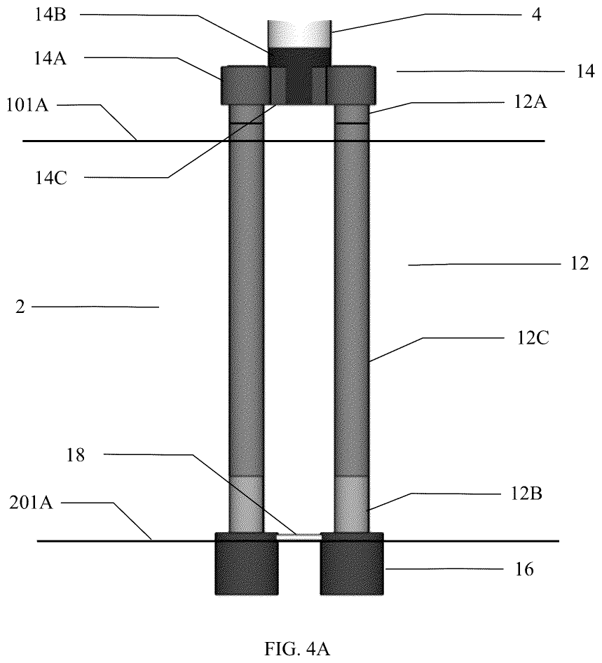

With reference to FIG. 6, in some embodiments, the upper section 12A of the elongate tubular leg 12 has a circular shell 32A with a diameter equal to an outer diameter of the upper section 12A, a plurality of outer guiding bars 34A attached to the outside of the circular shell 32A, an outer annulus plate 36A horizontally coupled to the circular shell 32A at a bottom, and a watertight cover plate 38 at a top, wherein a vertical distance from the outer annulus plate 36A to the watertight cover plate 38 is approximately equal to the height of the circular sleeve 14A.

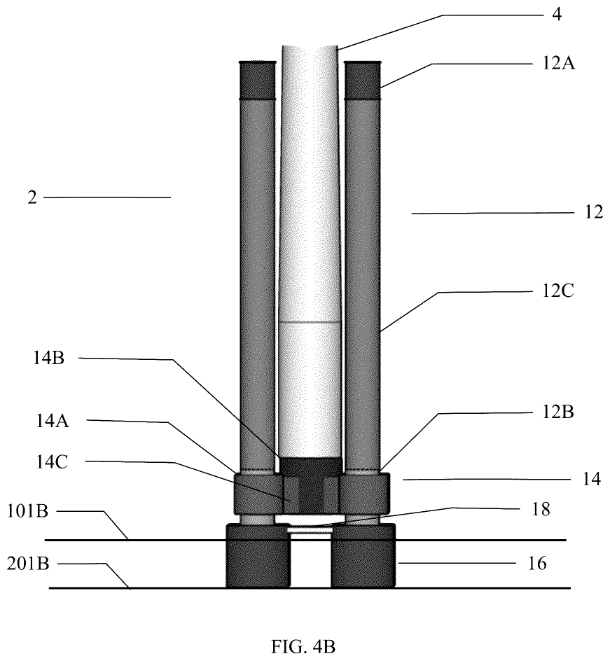

With reference to FIG. 7, in some embodiments, the inner diameter of the inner annulus plate 36 of the circular sleeve 14A is at least 1 inch greater than the outer diameter the upper section 12A with the outer guiding bars 34A, wherein the elongate tubular leg 12 can move vertically through the open circle of the inner annulus plate 36 of the circular sleeve 14A until the outer annulus plate 36A of the upper section 12A touches the inner annulus plate 36, wherein dimensions of the outer annulus plate 36A of the upper section 12A of the elongate tubular leg 12 are approximately equal to that of the inner annulus plate 36 of the circular sleeve 14A. The diameter of the circular outer shell 32 of the circular sleeve 14A is greater than the diameter of the circular shell 32A of the upper section 12A of the elongate tubular leg 12 forming an annulus space 33 in between, wherein a grout material is filled in the annulus space 33 forming a rigid connection between the circular sleeve 14A and the upper section 12A of the elongate tubular leg 12.

With reference to FIG. 8, in some embodiments, the circular sleeve 14A comprises a circular outer shell 42 having a diameter and a height, a plurality of inner guiding elements 44 vertically coupled to the inside of the circular outer shell 42, an inner annulus plate 46A horizontally coupled to a lower end of the circular outer shell 42, wherein the inner annulus plate 46A has an inner diameter approximately equals to a diameter of a circle formed by the inner guiding elements 44, and a T-shaped element 48A vertically coupled to the inside of the circular outer shell 42. The circular outer shell 42 of the circular sleeve 14A is coupled to a top flange plate 52A, a vertical web plate 54A, and a bottom flange plate 56A of the horizontal girder 14C.

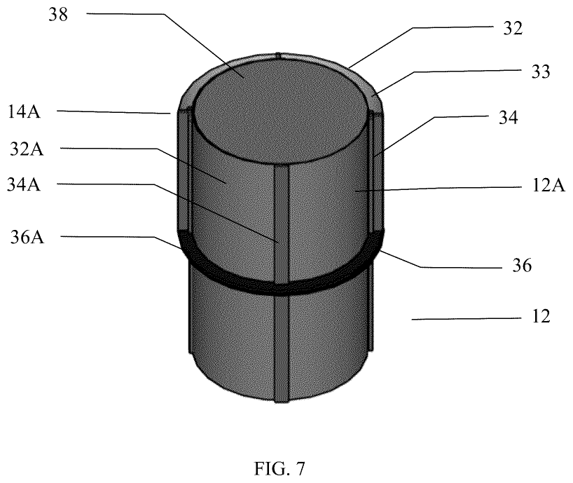

With reference to FIG. 9, in some embodiments, the upper section 12A of the elongate tubular leg 12 comprises essentially an upper part having a top horizontal extending plate 52B, a vertical web plate 54B and a vertical side plate 48B, and a lower part having a circular shell 62 with a diameter equal to an outer diameter of the upper section 12A, a plurality of outer guiding bars 64 attached to the outside of the circular shell 62, an outer annulus plate 46B and a watertight cover plate 66 at same elevation both horizontally coupled to the circular shell 62 at a top of the lower part, wherein a vertical distance from the outer annulus plate 46B to the top horizontal plate 52B is slightly greater than a height of the horizontal girder 14C.

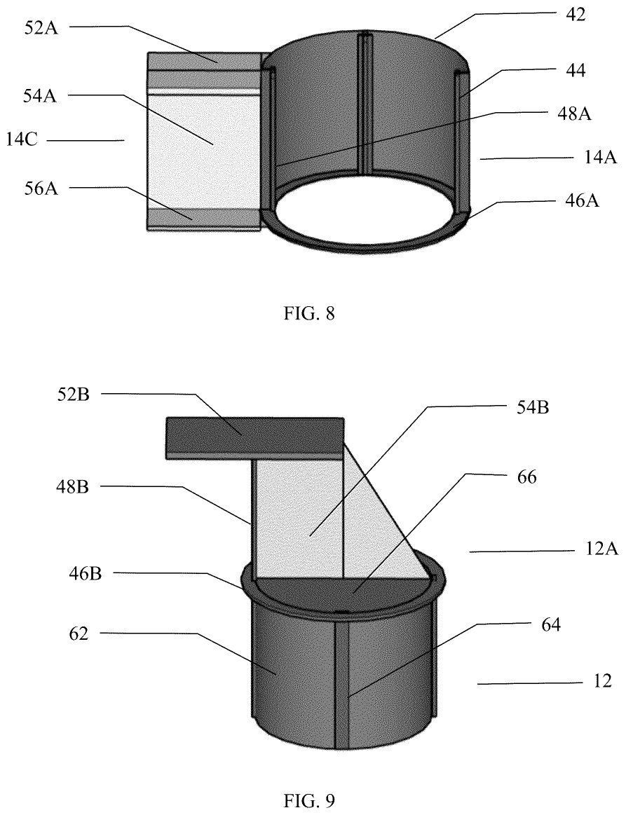

With reference to FIG. 10A and FIG. 10B, in some embodiments, the inner diameter of the inner annulus plate 46A of the circular sleeve 14A is at least 1 inch greater than the outer diameter the upper section 12A with the outer guiding bars 64, wherein the elongate tubular leg 12 can move vertically through the open circle of the inner annulus plate 46A of the circular sleeve 14A until the outer annulus plate 46B of the upper section 12A touches the inner annulus plate 46A, wherein dimensions of the outer annulus plate 46B of the upper section 12A of the elongate tubular leg 12 are approximately equal to that of the inner annulus plate 46A of the circular sleeve 14A. A plurality of steel bolts 68A, 68B and 68C are utilized to provide rigid connection between the upper section 12A of the elongate tubular leg 12 and the circular sleeve 14A and the horizontal girder 14C. Specifically, the top flange plate 52A of the horizontal girder 14C is coupled to the top horizontal extending plate 52B of the upper section 12A of the elongate tubular leg 12 by the steel bolts 68A, the T-shaped element 48A is coupled to the vertical side plate 48B by the steel bolts 68B, and the inner annulus plate 46A is coupled to the outer annulus plate 46B by the steel bolts 68C.

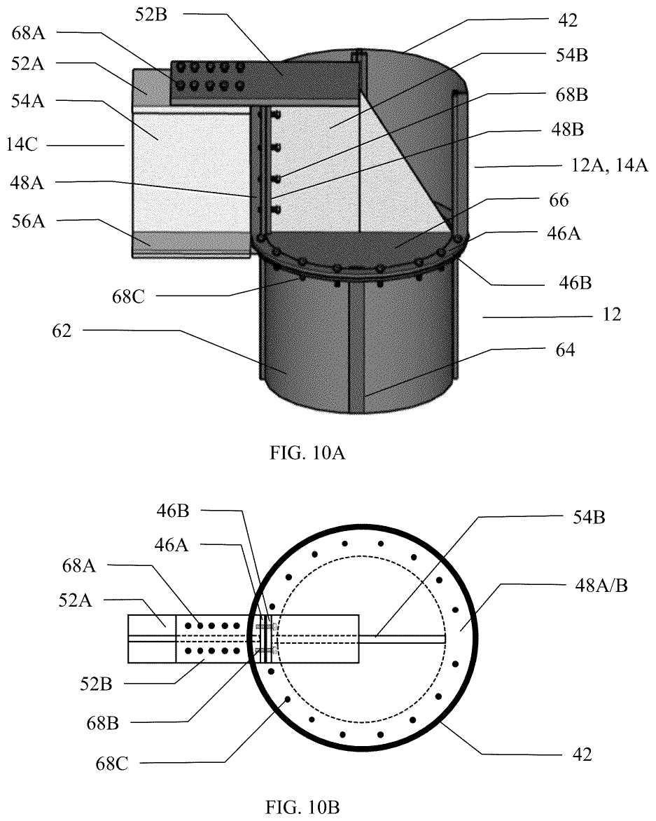

With reference to FIG. 11A, in some embodiments, the portal frame platform having four elongate tubular legs 12 supporting a wind turbine system 4, 6, 8 is in an offshore installation configuration, wherein the elongate tubular legs 12 extending vertically upward with the upper section 12A way above the deck 14 and each of the lower section 12B concentrically located inside of each of the circular sleeves 14A just above the foundation piles 16, wherein two barges 72 each having two deck support structures 74 connected to opposite sides of the horizontal deck 14 forming a catamaran providing buoyancy and stability for the portal frame platform 2 with the wind turbine system 4, 6, 8 and pile foundations 16 during sea-towing and offshore installation, wherein four lateral guides 76 each having a first end horizontally coupled to the upper section 12A of each of the elongate tubular legs 12 and a second end in contact with the wind tower 4.

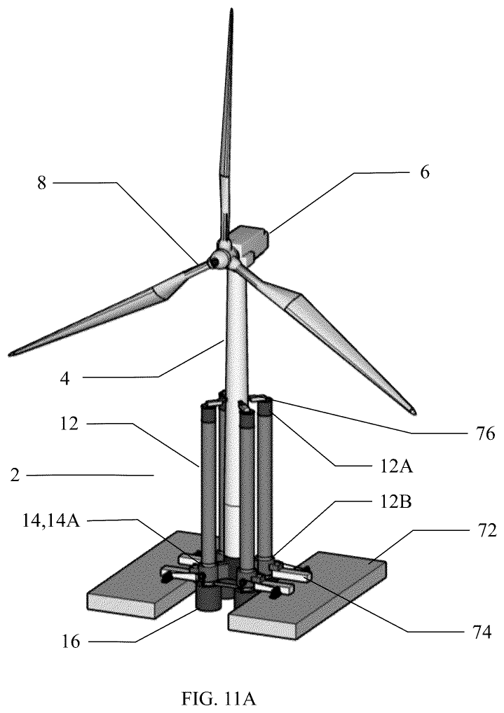

With reference to FIG. 11B, in some embodiments, the portal frame platform 2 supporting the wind turbine system 4, 6, 8 comprises three elongate tubular legs 12 in an offshore installation configuration, wherein each of the lower section 12B of the elongate tubular legs 12 is concentrically located inside each of the circular sleeves 14A of the horizontal deck 14 just above the foundation piles 16, wherein two barges 72 having one or two deck support structures 74 connected to opposite sides of the horizontal deck 14 forming a catamaran providing buoyancy and stability for the portal frame platform 2 with the wind turbine system 4, 6, 8 and pile foundations 16 during sea-towing and offshore installation, wherein three lateral guides 76 each having a first end horizontally coupled to each of the upper section 12A of the elongate tubular legs 12 and a second end in contact with the wind tower 4. With reference to FIG. 12, in some embodiments, each of the lateral guides 76 includes a housing structure 76A, a hydraulic cylinder 76B with an adjustable length coupled to the housing structure 76A, and a spring device 76C whose length varies with a compression force having one end coupled to the hydraulic cylinder 76B and a second end in contact with the wind tower 4 providing lateral support to each of the elongate tubular legs 12.

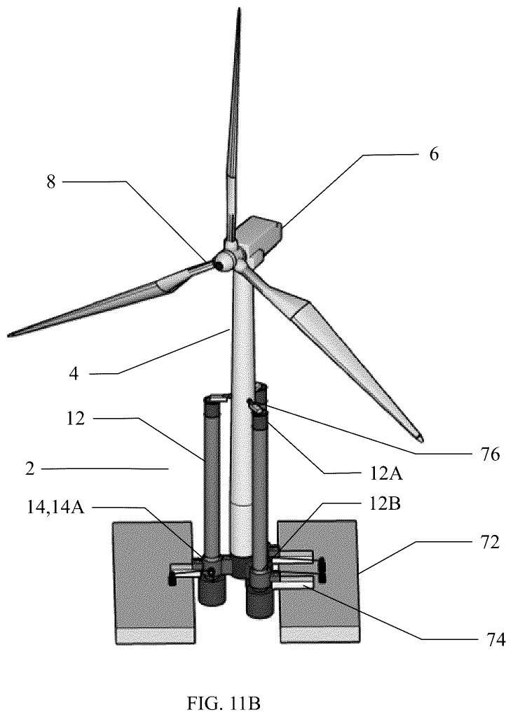

With reference to FIG. 13, in some embodiments, each of the two barges 72 is equipped with two deck support structures 74 and two sets of wire and winch systems each having a wire 84A, and a winch 84B. Each of the deck support structures 74 is coupled rigidly to a top of each of the barges 72 at one end and to the horizontal deck 14 at a second end with a quick release device 82 having a mechanism to separate the barge 72 with the horizontal deck 14 in a short time (typically a few seconds). Each of the wire 84A having one end connected to the winch 84B, running through a sheave 86 attached to the horizontal deck 14 and extending downward to a second end connected to a padeye 88 located on a top of each of the foundation piles 16.

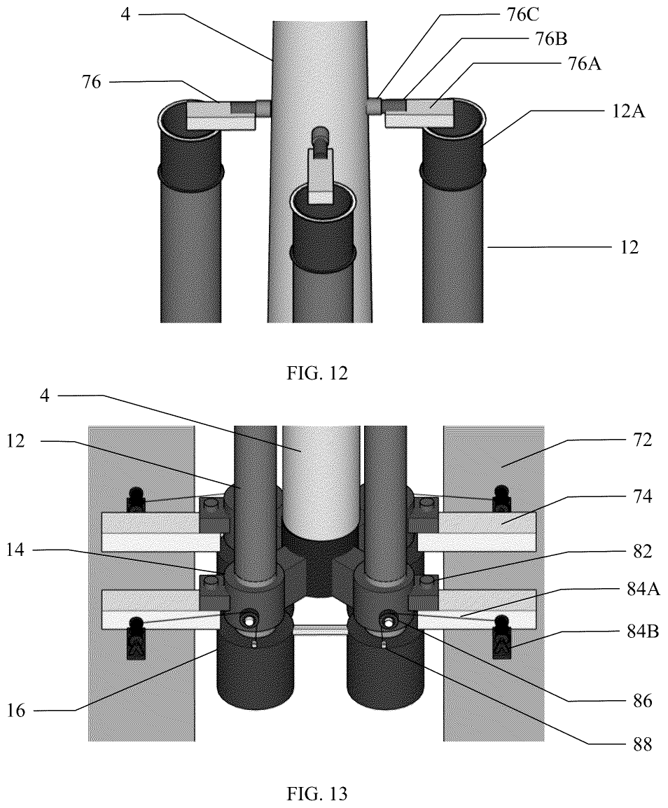

A construction method for quayside assembly, sea-towing, and offshore self-installation of a portal frame platform with a wind turbine system is described in detail below. The construction method comprises twelve steps in sequence with references to FIG. 14 to FIG. 25. Specifically, the portable frame platform 2 is constructed through three configurations comprising: first, forming a quayside assembly configuration (Step I to Step VI) with the elongate tubular legs 12 extending vertically upward from the horizontal deck 14 above a waterline for vertical integration with the wind turbine system 4, 6, 8 and the suction caisson foundation piles 16 at a quayside; second, forming an offshore installation configuration (Step VII and Step VIII) for sea-towing and self-installation by connecting two barges 72 to the quayside assembly configuration providing buoyancy and stability, and third, forming an in-service configuration (Step IX to Step XII) wherein the portal frame platform 2 is converted from the offshore installation configuration into the in-service configuration by lowering the elongate tubular legs 12 with the suction caisson foundation piles 16 to the seabed 201 utilizing the wire and winch systems 84A and 84B, embedding the suction caisson foundation piles 16 into the seabed 201, and disconnecting and pulling away the two barges 72.

It is assumed that the components of the portal frame platform 2, such as the elongate tubular legs 12, the horizontal deck 14, and the foundation piles 16 are prefabricated, as well as the components of the wind turbine system including the wind tower 4, nacelle 6, and rotor blades 8.

With reference to FIG. 14, in some embodiments, a Step I of the construction method is connecting a plurality of suction caisson foundation piles 16 in an upright configuration together with a plurality of link beams 18 at a top forming a sub-assembly 301 of a symmetrical pattern onshore, and lifting the sub-assembly 301 into a water at a quay of an assembly yard and having the sub-assembly stand on a seabed 401 with the top above a waterline 501.

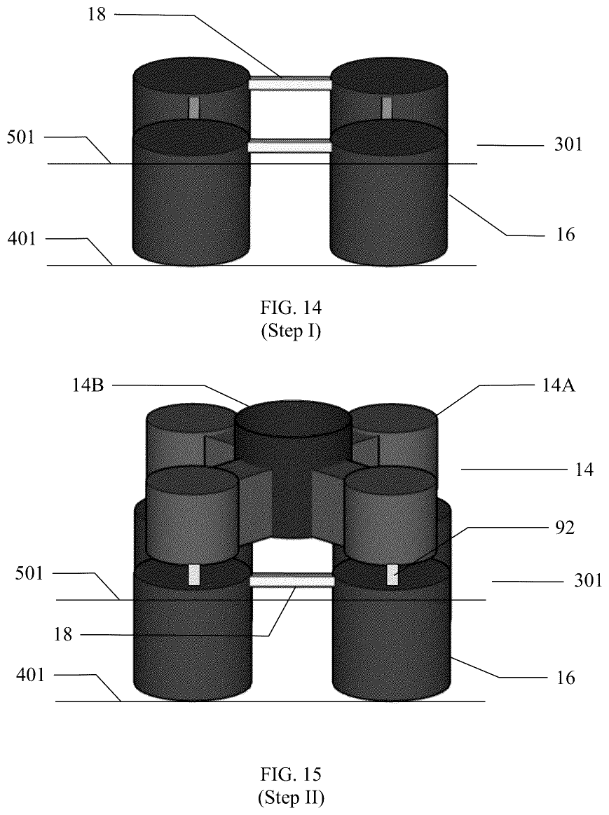

With reference to FIG. 15, in some embodiments, a Step II of the construction method is lifting a horizontal deck 14 onto the top of the sub-assembly 301 standing on the seabed 401 with each of the circular sleeves 14A directly above each of the suction caisson foundation piles 16 and the base section 14B at a center of the symmetrical pattern, and coupling the horizontal deck 14 with the sub-assembly 301 by a plurality of sea-fastenings 92 above the waterline 501.

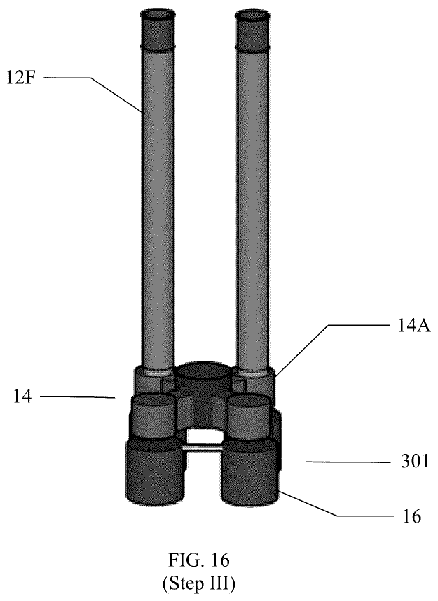

With reference to FIG. 16, in some embodiments, a Step III of the construction method is lifting at least one elongate tubular leg 12F vertically onto the top of the subassembly 301 through an opening of the circular sleeve 14A on a distal side from the quay of the horizontal deck 14 and coupling a bottom of the elongate tubular leg 12F to a top of the suction caisson foundation pile 16 on the distal side.

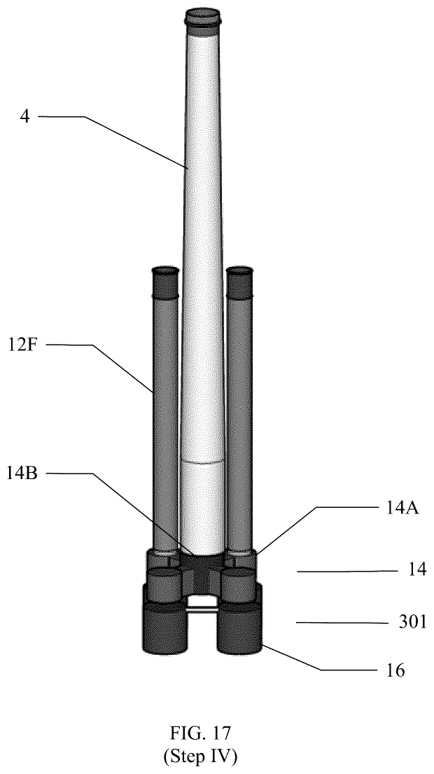

With reference to FIG. 17, in some embodiments, a Step IV of the construction method is lifting a wind tower 4 vertically and coupling a bottom of the wind tower 4 to a top of a base section 14B of the horizontal deck 14 above the subassembly 301 of the suction caisson foundation piles 16.

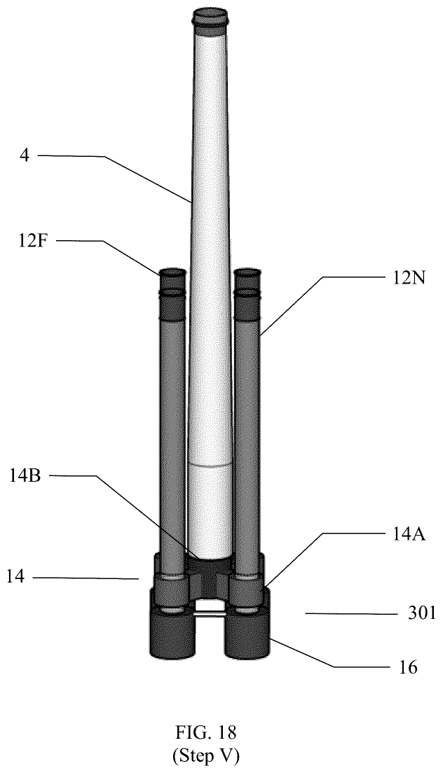

With reference to FIG. 18, in some embodiments, a Step V of the construction method is lifting at least one elongate tubular leg 12N vertically onto the top the subassembly 301 through an opening of the circular sleeve 14A on a proximal side from the quay of the horizontal deck 14 and coupling a bottom of the elongate tubular leg 12N vertically to a top of the suction caisson foundation pile 16 on the proximal side.

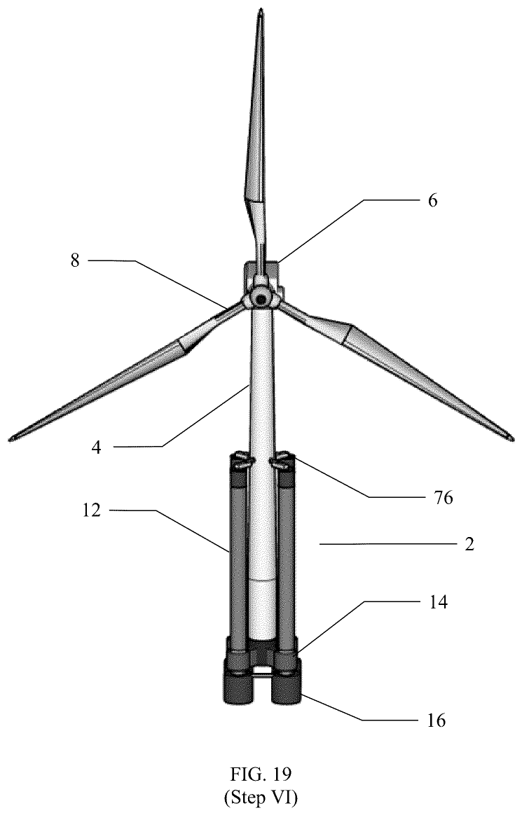

With reference to FIG. 19, in some embodiments, a Step VI of the construction method is installing each of the lateral guides 76 onto a top of each of the elongate tubular legs 12, lifting and coupling the nacelle 6 to a top of the wind tower 4, and lifting and coupling the rotor blades 8 to the nacelle 6. A quayside assembly configuration of the portal frame platform 2 is now completed with the wind turbine system 4, 6, 8 and foundation piles 16.

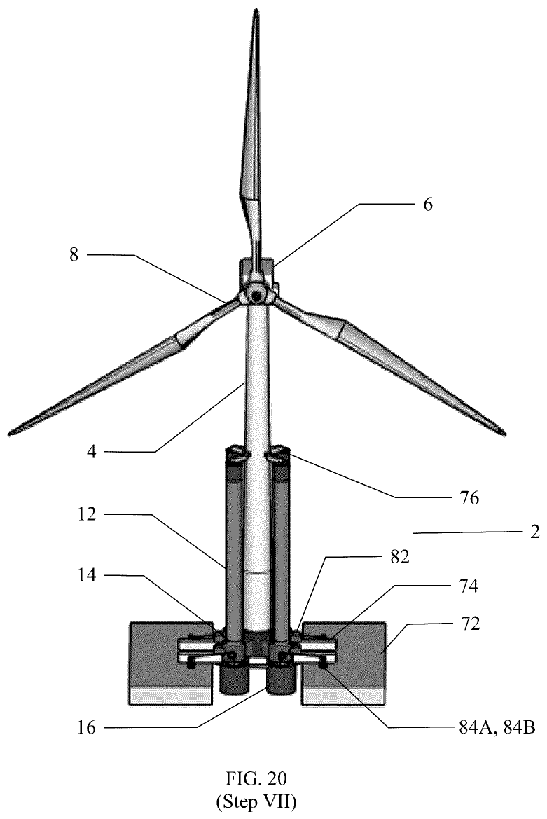

With reference to FIG. 20, in some embodiments, a Step VII of the construction method is connecting two barges 72 to opposite sides of the horizontal deck 14 forming a catamaran providing buoyancy and stability for the quayside assembly configuration of the portal frame platform 2, wherein each of the two barges 72 is equipped with two deck support structures 74 and two sets of wire and winch system 84A, 84B. This is done by having one end of each of the deck support structures 74 coupled to the horizontal deck 14 with a quick release device 82, wherein each of the wire and winch systems 84A, 84B having a wire with one end connected to a winch, running through each of the sheaves (not shown for clarity, reference to FIG. 13) attached to the horizontal deck and extending downward to a second end connected to each of the padeyes (not shown for clarity, reference to FIG. 13) located on a top of each of the foundation piles. An offshore installation configuration of the portal frame platform 2 is now completed with the wind turbine system 4, 6, 8 and foundation piles 16.

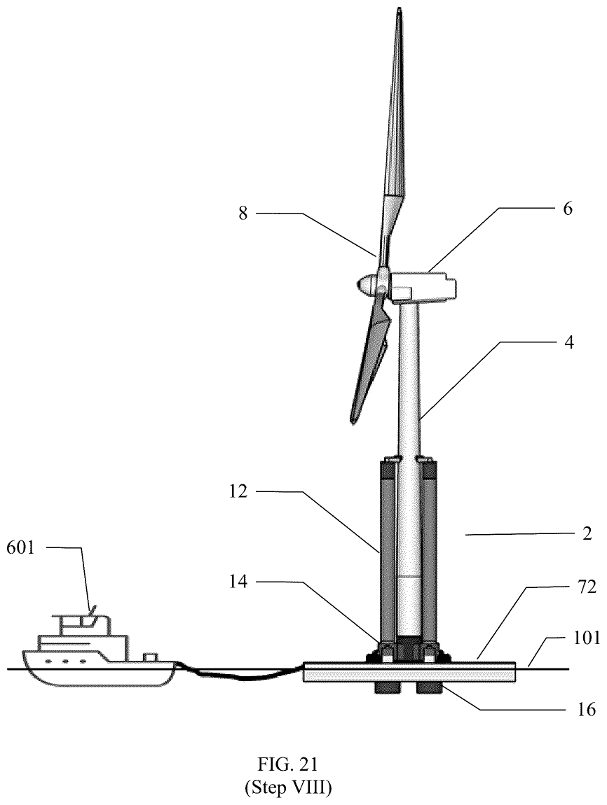

With reference to FIG. 21, in some embodiments, a Step VIII of the construction method is towing the portal frame platform 2 with the wind turbine system 4, 6, 8 and the suction caisson foundation piles 16 in the offshore installation configuration with a tugboat 601 from the assembly yard to an offshore site, wherein the two barges 72 connected to opposite sides of the horizontal deck 14 provide buoyancy and stability during sea-towing.

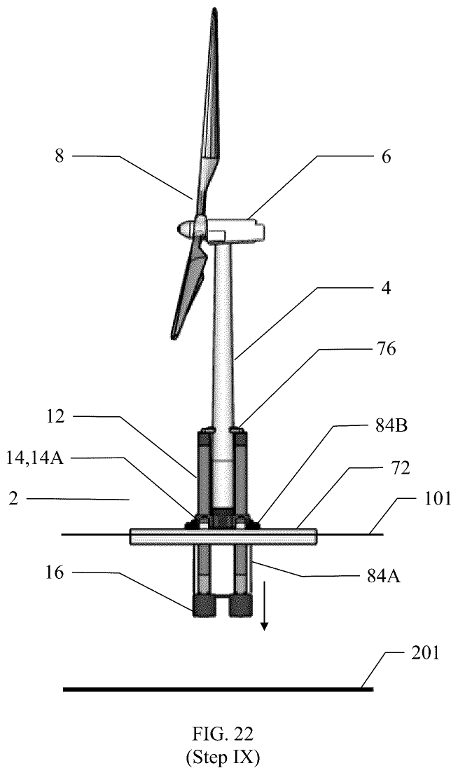

With reference to FIG. 22, in some embodiments, a Step IX of the construction method is converting the portal frame platform 2 with the wind turbine system 4, 6, 8 from the offshore installation configuration to an in-service configuration with a self-installation process by releasing the sea-fastenings (not shown for clarity) connecting the horizontal deck 14 above a waterline 101 and the suction caisson foundation piles 16 and allowing the elongate tubular legs 12 with the suction caisson foundation piles 16 to have a downward movement under gravity toward a seabed 201 through the circular sleeves 14A of the horizontal deck 14, and controlling the downward movement using the wire and winch systems 84A and 84B, wherein the two barges 72 connected to opposite sides of the horizontal deck 14 provide buoyancy and stability, and the lateral guides 76 moving downward with the elongate tubular legs 12 remain in contact with the wind tower 4 providing lateral support to the elongate tubular legs 12 during the self-installation process.

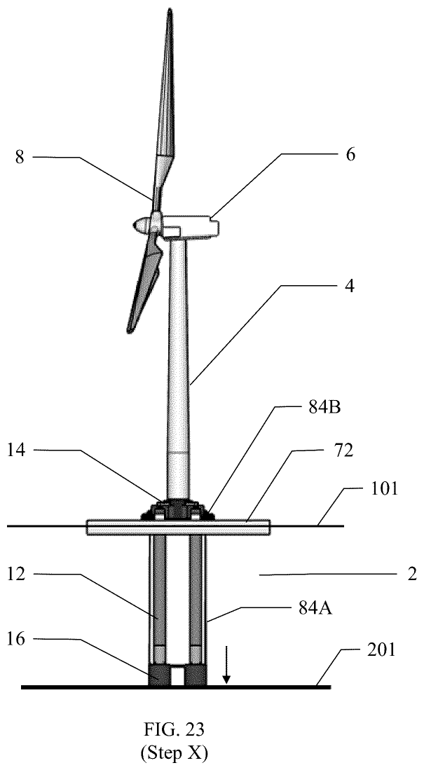

With reference to FIG. 23, in some embodiments, a Step X of the construction method is landing the suction caisson foundation piles 16 of the portal frame platform 2 with the wind turbine system 4, 6, 8 onto the seabed 201 by further lowering the elongate tubular legs 12 using the wire and winch systems 84A and 84B, wherein the two barges 72 connected to opposite sides of the horizontal deck 14 above the waterline 101 provide buoyancy and stability during the self-installation process.

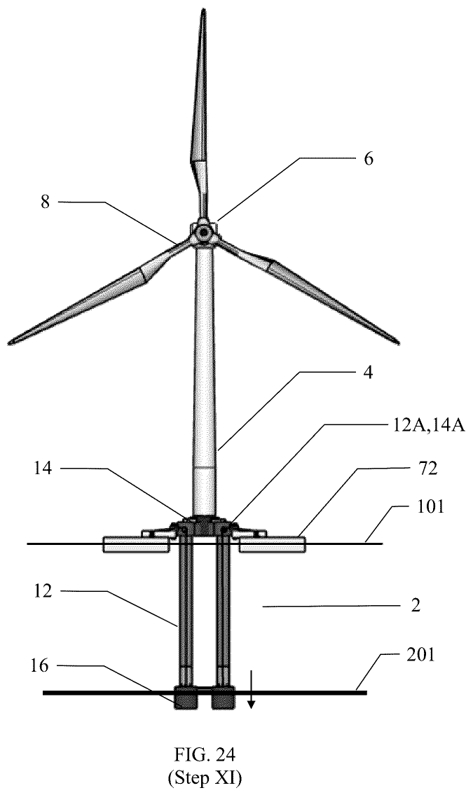

With reference to FIG. 24, in some embodiments, a Step XI of the construction method is embedding the suction caisson foundation piles 16 into the seabed 201 by suction forces, wherein the upper section 12A of each of the elongate tubular legs 12 is concentrically located into the circular sleeve 14A of the horizontal deck 14 forming an annulus space while the two barges 72 connected to opposite sides of the horizontal deck 14 above the waterline 101 provide buoyancy and stability during the self-installation process.

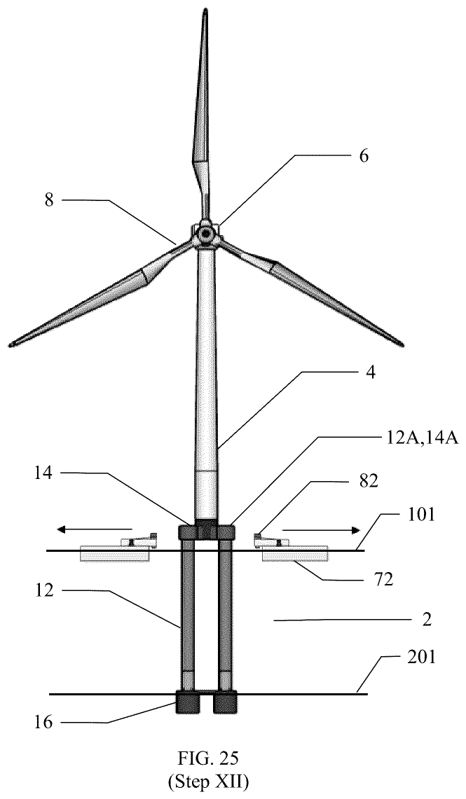

With reference to FIG. 25, in some embodiments, a Step XII of the construction method is forming a rigid connection between each of the elongated tubular legs 12 and the horizontal deck 14 of the portal frame platform 2 with the wind turbine system 4, 6, 8 by filling the annulus space between the upper section 12A of each of the elongated tubular legs 12 and each of the circular sleeves 14A of the horizontal deck 14 with grout and disconnecting the two barges 72 by activating the quick release devices 82 and pulling the two barges 72 away. The in-service configuration of the portal frame platform 2 is now completed with the wind turbine system 4, 6, 8 and foundation piles 16.

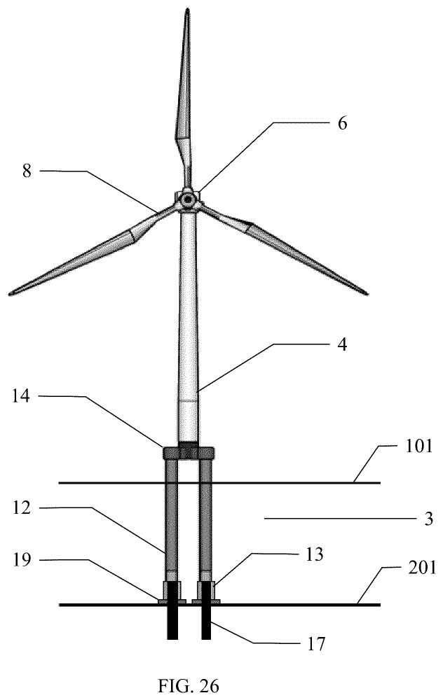

In some embodiments as shown in FIG. 26 to FIG. 29, the foundation piles are of a driven pile type for soil condition not favorable to the suction caisson type.

With reference to FIG. 26, a portal frame platform 3 supporting a wind turbine system consisting essentially of a wind tower 4, a nacelle 6 and rotor blades 8 includes an in-service configuration comprising a plurality of elongate tubular legs 12 having substantially more than one half of the length extending vertically downward below a waterline 101 without horizontal or diagonal bracing members between the elongate tubular legs 12, a plurality of pile adaption sections 13 each coupled to a bottom of each of the elongate tubular legs 12, a horizontal deck 14 above the waterline 101, a plurality of driven piles 17 embedded into a seabed 201 each having an upper section above the seabed 201 coupled to each of the pile adaption sections 13, wherein a center of the horizontal deck 14 is vertically coupled to a bottom of the wind tower 4, wherein each of the elongate tubular legs 12 is rigidly coupled to the horizontal deck 14 at a top by grouted or bolted connections.

The portable frame platform 3, in some embodiments, the driven piles 17 are preferred to have a diameter smaller than the diameter of the elongate tubular legs 12, having a diameter of the upper section of the driven piles 17 at least 2 inch smaller than a diameter of the pile adaption sections 13. The upper section of each of the driven piles 17 with a plurality of shear keys (not shown for clarity) on an outside is concentrically coupled to each of the pile adaption sections 13 with a plurality of shear keys (not shown for clarity) on an inside by grout above the seabed 201. The pile adaption section 13 may be concentrically coupled to the bottom of the elongate tubular leg 12 as shown, or with an offset to a centerline of the elongate tubular leg 12.

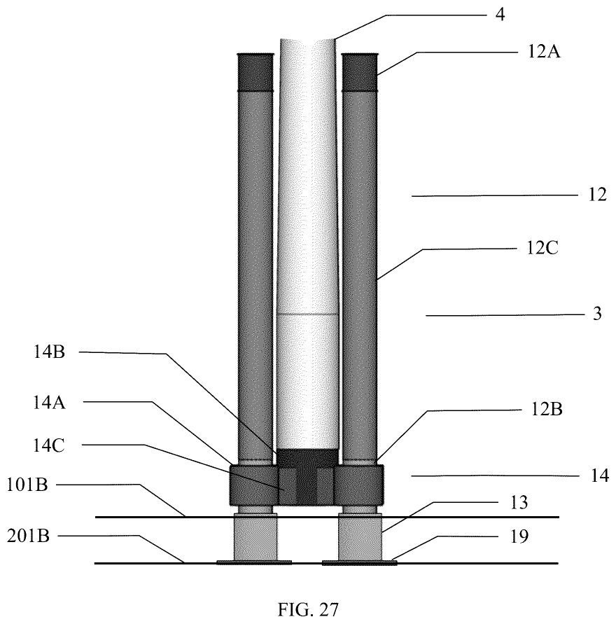

With reference to FIG. 27, the portal frame platform 3 has a quayside assembly configuration, as shown in approximately 8 meters water depth, wherein the elongate tubular legs 12 extend upward vertically having an upper section 12A way above a waterline 101B, the horizontal deck 14 having a plurality of circular sleeves 14A above the waterline 101B, and the pile adaption sections 13 each with a mud mat 19 at a bottom standing on a seabed 201B having a top coupled to a bottom of each of a lower section 12B of the elongate tubular legs 12 which is concentrically located inside each of the circular sleeves 14A at a similar elevation, wherein a base section 14B of the horizontal deck 14 is vertically coupled to the bottom of the wind tower 4 at a center, and a plurality of horizontal girders 14C each connecting the base section 14B to each of the circular sleeves 14A. The portable frame platform 3, in some embodiments, comprises at least three elongate tubular legs 12, at least three pile adaption sections 13, at least three driven piles 17, at least three circular sleeves 14A connected by at least three horizontal girders 14C to the base section 14B of the horizontal deck 14 forming a symmetrical pattern in a horizontal plan, wherein the bottom of the wind tower 4 of the wind turbine system is vertically coupled to the base section 14C at a center of the symmetrical pattern;

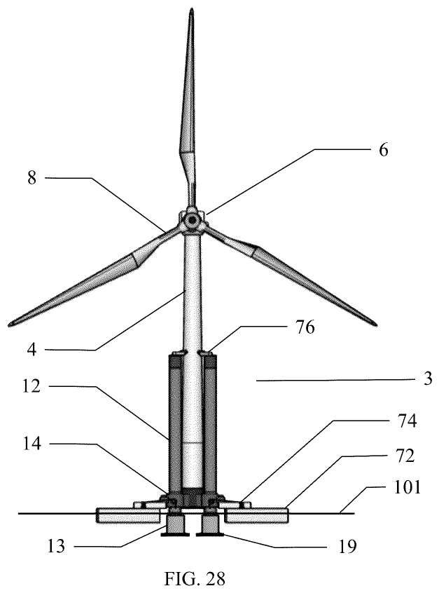

With reference to FIG. 28, in some embodiments, the portal frame platform 3 has an offshore installation configuration, wherein each of the elongate tubular legs 12 extends vertically with a lower end coupled to the pile adaption sections 13 with the mud mat 19 at a similar elevation as the horizontal deck 14 just above a waterline 101, wherein two barges 72 each having at least one deck support structure 74 are connected to opposite sides of the horizontal deck 14 forming a catamaran providing buoyancy and stability for the portal frame platform 3 with the wind turbine system 4, 6, 8 during sea-towing and offshore installation, wherein a plurality of lateral guides 76 each having a first end horizontally coupled to a top of each of the elongate tubular legs 12 and a second end in contact with the wind tower 4 providing lateral stability to the elongate tubular legs 12.

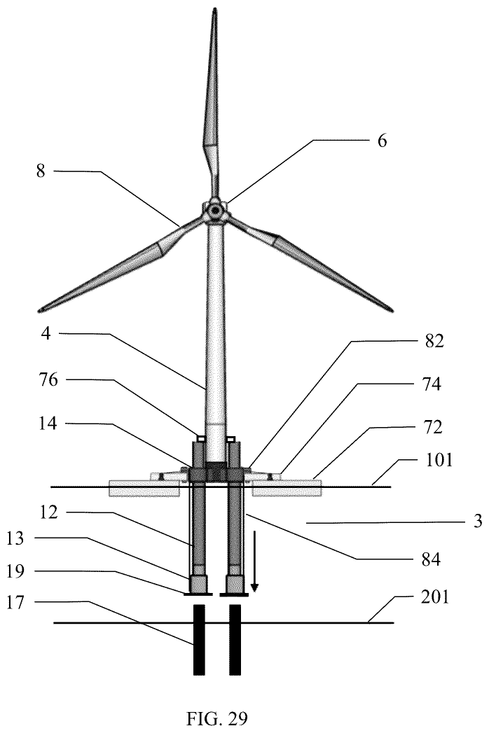

With reference to FIG. 29, in some embodiments, the portal frame platform 3 with the wind turbine system 4, 6, 8 is being converted from the offshore installation configuration into the in-service configuration in a self-installation process at an offshore site by lowering the elongate tubular legs 12 with the pile adaption section 13 and the mud mat 19 to the driven piles 17 using wire and winch systems 84, wherein the two barges 72 are connected to opposite sides of the horizontal deck 14 by the deck support structures 74 and quick release devices 82 providing buoyancy and stability during the self-installation process. The driven piles 17 are pre-installed at the offshore site by impact hammer forces with the upper section above the seabed 201 for coupling with the pile adaption section 13.

It is easy to see that the portable frame platform 3 with the driven piles 17 described above with references to FIG. 26 to FIG. 29 can be assembled at a quayside, vertically towed offshore, and self-installed using a similar construction method with the steps described earlier in this disclosure with references to FIG. 14 to FIG. 25 without using heavy lift vessels.

The above descriptions and figures are exemplary embodiments of the present invention and preferred main features of a bottom-founded portal frame platform and construction method for supporting a large offshore wind turbine. The portal frame platform is preferred to be of steel construction and has a preferred service water depth range from 30 meters to 100 meters. The elongate tubular legs have a preferred diameter significantly less than the diameter of the wind tower which typically has a range from 6 meters to 10 meters depending on the wind turbine size. However, the portable frame platform is not limited to the above water depth range and can be deployed to water depth less than 30 meters or more than 100 meters. Furthermore, the portable frame platform is not limited to supporting wind turbines and can be utilized to support other types of topsides, such as substation equipment of an offshore wind farm. All modifications, equivalents, and alternatives to the above preferred embodiments are to be covered in the spirit and scope of the present invention.

What is claimed is:

1. A portable frame platform, comprising:
a plurality of elongate tubular legs extending vertically each comprising an upper section, a mid-section and a lower section;
a horizontal deck comprising a plurality of circular sleeves equally spaced radially from a center,
a base section located at the center and a plurality of horizontal girders each coupled to each of the circular sleeves at one end and the base section at a second end, wherein each of the circular sleeves having a diameter greater than a diameter of each of the elongate tubular legs, wherein each of the elongate tubular legs concentrically located in an inside of each of the circular sleeves with an annulus space in-between;
a wind turbine system comprising a wind tower vertically coupled to the base section of the horizontal deck at a bottom, a nacelle coupled to a top of the wind tower, and a plurality of rotor blades coupled to the nacelle;
a plurality of foundation piles each vertically coupled to a bottom of each of the elongate tubular legs, wherein the foundation piles are of a suction caisson type with a diameter substantially greater than the diameter of the elongate tubular legs;
a plurality of link beams connecting the foundation piles at a top;
a plurality of lateral guides each attached to a top of each of the elongate tubular legs;
an in-service configuration in a water at an offshore site, wherein the elongate tubular legs having substantially more than one half of a length extending downward vertically below a waterline to a seabed without horizontal or diagonal bracing members between the elongate tubular legs, wherein the upper section of each of the elongate tubular legs concentrically coupled to the inside of each of the circular sleeves of the horizontal deck forming a rigid connection above the waterline, wherein the base section of the horizontal deck vertically coupled to the bottom of the wind tower of the wind turbine system, wherein the foundation piles vertically embedded into the seabed;
a quayside assembly configuration in a water at a quayside of an assembly yard, wherein the foundation piles connected by the link beams vertically standing on a seabed and the elongate tubular legs having substantially more than one half of the length extending upward vertically above a waterline without horizontal or diagonal bracing members between the elongate tubular legs, wherein the lower section of each of the elongate tubular legs concentrically located in the inside of each of the circular sleeves of the horizontal deck above the waterline, wherein the base section of the horizontal deck vertically coupled to the bottom of the wind tower of the wind turbine system and the horizontal deck coupled to the foundation piles by a plurality of sea-fastenings; and
an offshore installation configuration, wherein the quayside assembly configuration having two barges connected to opposite sides of the horizontal deck forming a catamaran floating system for sea-towing and offshore installation.

2. The portable frame platform of claim 1, wherein consisting essentially of at least three elongate tubular legs, at least three foundation piles, and a horizontal deck having a base section and at least three circular sleeves connected by at least three horizontal girders to the base section forming a symmetrical pattern in a horizontal plan, wherein the bottom of the wind tower of the wind turbine system is vertically coupled to the base section of the horizontal deck at a center of the symmetrical pattern.

3. The portable frame platform of claim 1, wherein the rigid connection between the upper section of each of the elongate tubular legs and each of the circular sleeves of the horizontal deck is of a grouted type having an annulus space filled with grout.

4. The portable frame platform of claim 3, wherein each of the circular sleeves of the horizontal deck comprising a circular outer shell having a diameter and a height, a plurality of inner guiding elements vertically coupled to the inside of the circular outer shell, and an inner annulus plate horizontally coupled to a lower end of the circular outer shell, wherein the inner annulus plate having an inner diameter approximately equal to a diameter of a circle formed by the inner guiding elements.

5. The portable frame platform of claim 3, wherein each of the upper section of the elongate tubular legs comprising a circular shell with a diameter equal to an outer diameter of the upper section, a plurality of outer guiding bars attached to an outside of the circular shell, an outer annulus plate horizontally coupled to the circular shell at a bottom, and a watertight cover plate at a top, wherein a vertical distance from the outer annulus plate at the bottom to the watertight cover plate at the top is approximately equal to the height of the circular sleeve. The inner diameter of the inner annulus plate of the circular sleeve is at least 1 inch greater than the outer diameter the upper section of the elongate tubular leg with the outer guiding bars, wherein the elongate tubular leg can move vertically through an open circle of the inner annulus plate of the circular sleeve until the outer annulus plate of the upper section touches the inner annulus plate, wherein having dimensions of the outer annulus plate of the upper section approximately equal to that of the inner annulus plate of the circular sleeve.

6. The portable frame platform of claim 3, wherein the diameter of the circular outer shell of the circular sleeve is greater than the diameter of the circular shell of the upper section of the elongate tubular leg forming an annulus space in-between, wherein a grout material filled in the annulus space forming a rigid connection between the circular sleeve of the horizontal deck and the upper section of the elongate tubular leg.

7. The portable frame platform of claim 1, wherein the rigid connection between each of the upper section of the elongate tubular legs and the horizontal deck is of a bolted type having a plurality of steel bolts connecting various parts of the upper section of each of the elongate tubular legs to each of the horizontal girders and the circular sleeves of the horizontal deck, wherein the upper section comprises essentially an upper part having a height with a top horizontal extending plate, a vertical web plate and a vertical side plate, and a lower part having a circular shell with a diameter equal to an outer diameter of the upper section, a plurality of outer guiding bars attached to an outside of the circular shell, an outer annulus plate and a watertight cover plate horizontally coupled to the circular shell at a top of the lower part.

8. The portable frame platform of claim 7, wherein each of the circular sleeves of the horizontal deck comprising a circular outer shell having a diameter and a height approximately equal to the height of the upper part of the upper section of the elongate tubular leg, a plurality of inner guiding elements vertically coupled to an inside of the circular outer shell, an inner annulus plate horizontally coupled to a lower end of the circular outer shell, wherein the inner annulus plate having an inner diameter approximately equal to a diameter of a circle formed by the inner guiding elements, and a T-shaped element vertically coupled to the inside of the circular outer shell, wherein the circular outer shell is coupled to a top flange plate, a vertical web plate, and a bottom flange plate of a horizontal girder of the horizontal deck.

9. The portable frame platform of claim 7, wherein the top flange plate of each of the horizontal girders of the horizontal deck is bolted to the top horizontal extending plate of each of the upper section of the elongate tubular legs, the T-shaped element and the inner annulus plate of each of the circular sleeves of the horizontal deck are bolted to the vertical side plate and the outer annulus plate of the upper section of each of the elongate tubular legs, respectively.

10. The portable frame platform of claim 1, wherein the quayside assembly configuration including at least three lateral guides each having one end connected to a top of each of elongate tubular legs and a second end in contact with the wind tower.

11. The portable frame platform of claim 10, wherein each of the lateral guides including a housing structure, a hydraulic cylinder having an adjustable length coupled to the housing structure, and
a spring device having a length varying with a compression force with one end coupled to the hydraulic cylinder and a second end compressed to the wind tower.

12. The portable frame platform of claim 1, wherein having each of the two barges equipped with at least one deck support structure and one wire and winch system, wherein the deck support structure is coupled to a top of the barge at one end and to the horizontal deck at a second end with a quick release device, wherein the quick release device having a mechanism to separate the barge with the horizontal deck in seconds.

13. The portable frame platform of claim 12, wherein the wire and winch system consisting essentially of a winch and a wire having one end connected to the winch located on the top of the barge, miming through a sheave attached to the horizontal deck and extending downward to a second end connected to a padeye located on a top of the foundation pile.

14. A method for constructing a portal frame platform, comprising
a plurality of elongate tubular legs extending vertically each comprising an upper section, a mid-section and a lower section;
a horizontal deck comprising a plurality of circular sleeves equally spaced radially from a center, a base section located at the center and a plurality of horizontal girders each coupled to the base section at one end and each of the circular sleeves at a second end, wherein the circular sleeves having a diameter greater than a diameter of the elongate tubular legs;
a wind turbine system comprising a wind tower, a nacelle, and a plurality of rotor blades;
a plurality of suction caisson foundation piles;
a plurality of link beams;
a plurality of lateral guides; and
the method comprising:
STEP I, connecting the suction caisson foundation piles in an upright configuration with the link beams at a top forming a sub-assembly of a symmetrical pattern onshore, and
lifting the sub-assembly into a water at a quay of an assembly yard and having the sub-assembly stand on a seabed with the top above a waterline;
STEP II, lifting the horizontal deck onto the top of the sub-assembly with each of the circular sleeves directly above each of the suction caisson foundation piles and the base section at a center of the symmetrical pattern, and coupling the horizontal deck with the sub-assembly by sea-fastenings above the waterline;
Step III, lifting at least one elongate tubular leg vertically onto the top of the sub-assembly through an opening of the circular sleeve of the horizontal deck on a distal side from the quay and coupling a bottom of the elongate tubular leg to a top of the suction caisson foundation pile on the distal side;
Step IV, lifting the wind tower vertically and coupling a bottom of the wind tower to a top of the base section of the horizontal deck;
Step V, lifting at least one elongate tubular leg vertically onto the top of the sub-assembly through an opening of the circular sleeve of the horizontal deck on a proximal side from the quay and coupling a bottom of the elongate tubular leg to a top of the suction caisson foundation pile on the proximal side;
Step VI, installing each of the lateral guides onto a top of each of the elongate tubular legs; lifting and coupling the nacelle to a top of the wind tower; lifting and coupling the rotor blades to the nacelle.

15. The method of claim 14, further comprising,
a plurality of sheaves attached to the horizontal deck;
a plurality of padeyes each attached to a top of each of the suction caisson foundation piles;
two barges;
a plurality of deck support structures coupled to a top of each of the barges;
a plurality of quick release devices each attached to each of the deck support structures;
a plurality of wire and winch systems comprising wires and winches; and
the method further comprising:
Step VII, connecting the two barges to opposite sides of the horizontal deck forming a catamaran in an offshore installation configuration by having one end with the quick release device of each of the deck support structures coupled to the horizontal deck, wherein each of the wire and winch systems having a wire with one end connected to a winch installed on the top of each of the barges, running through each of the sheaves and extending downward to a second end connected to each of the padeyes;
Step VIII, towing the portal frame platform with the wind turbine system and the suction caisson foundation piles in the offshore installation configuration from the quayside of the assembly yard to an offshore site with at least one tugboat;
Step IX, converting the portal frame platform from the offshore installation configuration to an in-service configuration with a self-installation process by releasing the sea-fastenings and allowing the elongate tubular legs to have a downward movement under gravity through the circular sleeves of the horizontal deck, and controlling the downward movement using the wire and winch systems, wherein the two barges connected to opposite sides of the horizontal deck providing buoyancy and stability and the lateral guides remaining in contact with the wind tower providing lateral support to the elongate tubular legs during the self-installation process;
Step X, landing the suction caisson foundation piles onto a seabed by further lowering the elongate tubular legs using the wire and winch systems;
Step XI, embedding the suction caisson foundation piles into the seabed by suction forces, wherein an upper section of each of the elongate tubular legs is concentrically located inside each of the circular sleeve of the horizontal deck forming an annulus space;
Step XII, forming a rigid connection between each of the upper section of the elongated tubular legs and each of the circular sleeves of the horizontal deck by filling the annulus space with grout, and disconnecting the two barges by activating the quick release devices and pulling the two barges away.

16. A portable frame platform, comprising:
a plurality of elongate tubular legs extending vertically each comprising an upper section, a mid-section, and a lower section;
a horizontal deck comprising a plurality of circular sleeves equally spaced radially from a center, a base section located at the center and a plurality of horizontal girders each connecting the base section at one end and each of the circular sleeves at a second end, wherein the circular sleeves having a diameter greater than a diameter of the elongate tubular legs, and each of the elongate tubular legs is concentrically located in an inside of each of the circular sleeves with an annulus space;
a wind turbine system comprising a wind tower, a nacelle, and a plurality of rotor blades;
a plurality of driven piles;
a plurality of pile adaption sections each coupled to a bottom of each of the elongate tubular leg concentrically or with an offset;
a plurality of mud mats each coupled to a bottom of each of the pile adaption sections;
a plurality of lateral guides each coupled to a top of each of the elongated tubular legs;
a quayside assembly configuration in a relative shallow water at a quayside of an assembly yard, wherein each of the elongate tubular legs having substantially more than one half of a length extending vertically upward above a waterline without horizontal or diagonal bracing members between the elongate tubular legs, wherein the pile adaption sections with the mud mats standing on a seabed coupled to the horizontal deck above the waterline by temporary sea-fastenings, and the lower section of each of the elongate tubular legs is concentrically located in an inside of each of the circular sleeves of the horizontal deck, and the base section of the horizontal deck is vertically coupled to a bottom of the wind tower of the wind turbine system; and
an in-service configuration in a relative deep water at an offshore site, wherein each of the elongate tubular legs having substantially more than one half of the length extending vertically downward below a waterline without horizontal or diagonal bracing members between the elongate tubular legs, wherein the driven piles each having a lower section embedded into a seabed and an upper section above the seabed concentrically coupled to each of the pile adaption sections attached to the elongate tubular legs, and the upper section of each of the elongate tubular legs is concentrically coupled to the inside of each of the circular sleeves of the horizontal deck above the waterline forming a rigid connection, and the base section of the horizontal deck is vertically coupled to the bottom of the wind tower of the wind turbine system.

17. The portable frame platform of claim 16, wherein comprises at least three elongate tubular legs, at least three pile adaption sections, at least three driven piles, at least three circular sleeves connected by at least three horizontal girders to the base section of the horizontal deck forming a symmetrical pattern in a horizontal plan, wherein the bottom of the wind tower of the wind turbine system is coupled vertically to the base section at a center of the symmetrical pattern;

18. The portable frame platform of claim 16, further comprising an offshore installation configuration wherein the quayside assembly configuration having two barges connected to opposite sides of the horizontal deck forming a catamaran floating system for sea-towing and offshore installation, wherein each of the two barges having at least one deck support structure with a quick release device and a least one set of wire and winch system;

19. The portable frame platform of claim 16, wherein the driven piles are pre-installed at the offshore site having a diameter at least 2 inch smaller than a diameter of the pile adaption sections, wherein each of the driven piles having a plurality of shear keys on an outside of the upper section above the seabed, and each of the pile adaption sections having a circular shell with a plurality of shear keys attached to an inside of the circular shell;

20. The portable frame platform of claim 16, wherein a self-installation process converting the portable frame platform from the offshore installation configuration into the in-service configuration by lowering the elongate tubular legs with the pile adaption sections to the seabed using the wire and winch systems, having each of the elongate tubular legs rigidly coupled to each of the circular sleeves of the horizontal deck at a top by grouted or bolted connections and each of the pile adaption sections concentrically coupled to each the upper section of the driven piles by grout, and disconnecting the two barges by activating the quick release devices and pulling the two barges away.
